(19) United States
(12) Patent Application Publication
(10) Pub. No.: US 2007/0251874 A1
(43) Pub. Date: Nov. 1, 2007

(54) COLLAPSIBLE STRAINING DEVICE

(75) Inventor: Joshua R. Stewart, Seattle, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Chef'n Corporation, Seattle, WA (US)

(21) Appl. No.: 11/380,829

(22) Filed: Apr. 28, 2006

(51) Int. Cl. B01D 29/37; B01D 29/35

(52) U.S. Cl. 210/232; 210/249; 210/473; 210/497.01; 210/498

(57) ABSTRACT

A device for straining liquids and particles from solid food items may comprise a collapsible container comprising a plurality of apertures and at least one transition operable to expand the collapsible container, forming a concavity to retain the food items during use, and to allow the user to collapse the collapsible container into a thin form for storage and/or transport after use. The collapsible container may comprise a rim and a base. The device may further comprise support members pivotably coupled to the rim of the container, operable to pivot in a first direction to an open position during use and to pivot in a second direction to a closed position for storage and/or transport after use.

### BACKGROUND OF THE INVENTION

1. Field of the Invention

The present invention is generally related to kitchenware, and more particularly, to a collapsible straining device.

2. Description of the Related Art

In the art of cooking, devices that separate liquids or other particles from solids are often used for various purposes including, but not limited to, washing food items such as vegetables, draining water-cooked foods such as pasta, drying food items such as lettuce, etc. Examples of such devices include colanders and strainers. Colanders are typically formed from a dish, platter, bowl, tray, or the like, having a plurality of holes spaced and sized to best suit specific applications. Strainers are similar to colanders, but incorporate wire mesh instead of a solid material having holes. Typically solid items such as food items are placed in a colander or strainer to drain or strain liquid or solids that are smaller in size than the respective holes of the colander or openings in the wire mesh. For example, when pasta is cooked in hot water, the pasta and the water are dispensed in a colander to allow the water drain and isolate the pasta for consumption. Furthermore, colanders or strainers are used to rinse or wash items such as vegetables. For example, lettuce can be placed in a colander and rinsed with water and the water along with any dirt or unwanted particles drain through the holes.

Despite their practicalities in use, colanders and strainers tend to be bulky and space consuming when stored or when placed in a dishwasher. Colanders are typically fabricated from metals and rigid plastics, which cannot deform and be compactly stored. Additionally, colanders typically include a flat base or supports extending from the base to secure it on a surface; therefore, they do not snuggly fit in other bowls or pots to save space when stored.

Accordingly, there is a need for a straining device that is lightweight, can be supported on a surface or other structure, and can be collapsed into a thin form for easy and compact storage and/or transport.

### BRIEF SUMMARY OF THE INVENTION

In one embodiment, the present invention provides a device for straining liquids and particles from solid food items, the device comprising a collapsible container operable to collapse into a thin form, the collapsible container having a plurality of apertures therein, a rim coupled to an outer edge of the collapsible container, and a base coupled to the collapsible container to remain a fixed distance from the rim during use and to set proximate thereto after use when the collapsible container is collapsed into the thin form.

In another aspect, the invention further comprises first and second coupling members slidably engaging the rim, and pivotably coupling first and second support members to the rim, respectively, each coupling member having first and second recesses, wherein a first force applied to the first and second coupling members respectively translates the coupling members from a first to a second position, shifting the first and second support members from the first recess to the second recess of the first and second coupling members, respectively, an interaction of a surface of the recesses with the first and second support members pivoting the first and second support members from a closed position to an open position, and a second force applied to the first and second coupling members respectively translates the coupling members from the second to the first position, shifting the first and second support members from the second recess to the first recess of the first and second coupling members, respectively, an interaction of the surface of the recesses with the first and second support members pivoting the first and second support members from the open position to the closed position.

### BRIEF DESCRIPTION OF THE SEVERAL VIEWS OF THE DRAWING(S)

FIG. 1 is an isometric view of a straining device according to one embodiment of the present invention.

FIG. 2 is a side view of one aspect of a straining device according to another embodiment of the present invention in a collapsed form.

FIG. 3 is a cross-sectional view of the straining device of FIG. 2 with a collapsible container expanded, viewed along section 3-3 of FIG. 5.

FIG. 4 is a cross-sectional view of the straining device of FIG. 2 in an expanded form, viewed along section 4-4 of FIG. 5.

FIG. 5 is a bottom plan view of the straining device of FIG. 2 with supporting members collapsed.

FIG. 6 is an isometric view of another aspect of the straining device of FIG. 2.

FIG. 7 is an isometric view of a straining device according to yet another embodiment of the present invention.

### DETAILED DESCRIPTION OF THE INVENTION

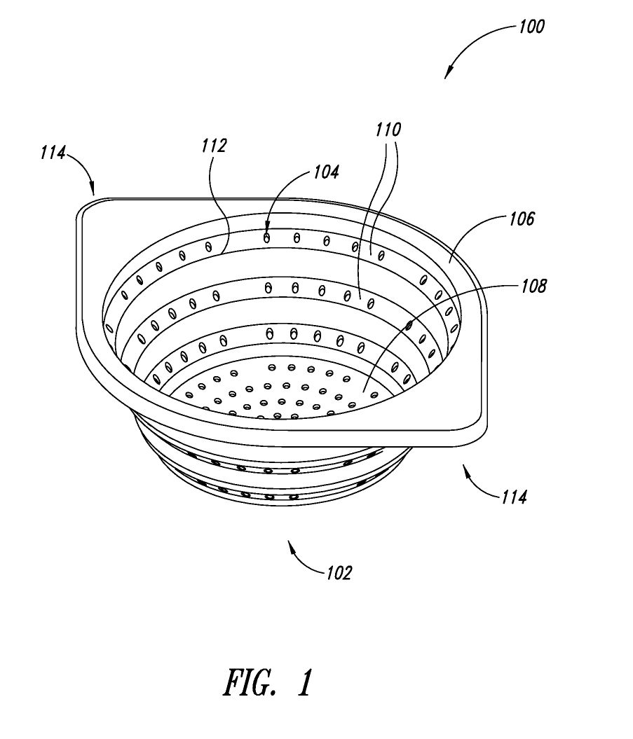

FIG. 1 illustrates a straining device 100 according to one embodiment of the present invention. The straining device 100 comprises a collapsible container 102 having a plurality of apertures 104 formed therein. The straining device 100 further comprises a rim 106 coupled to an outer edge of the collapsible container 102 and a base 108 coupled to the collapsible container 102 to remain a fixed distance from the rim 106 during use. The collapsible container 102 may comprise at least one wall 110. The apertures 104 can be formed in the base 108 and/or wall 110 of the collapsible container 102. In some embodiments the base 108 and wall 110 can be seamlessly integrated and fabricated from a deformable and/or flexible material such that the collapsible container 102 can transition between an expanded form, illustrated in FIG. 1, and a collapsed form as described in more detail below. For example, the collapsible container 102 can be fabricated, in whole or in part, from silicone, plastics, nylon, deformable wire mesh, films or foils, fabrics, synthetic or natural rubbers, or any combination thereof, or any other material sufficiently deformable and/or flexible to expand during use, for example in response to gravity and/or a weight of contents, and collapse into a thin form after use for storage and/or transport.

Additionally, or alternatively, the collapsible container 102 can be fabricated from other stiffer materials and include transitions 112 formed in the wall 110 and/or the base 108 adapted to promote collapsing the collapsible container 102 into the thin form. For example, the collapsible container 102 can be fabricated from material comprising metals such as aluminum, titanium or steel, soft or hard woods, silicone, soft or hard plastics, composites such as carbon fiber, or any combination thereof or any other material that can maintain a shape of the collapsible container 102. The transitions 112 may comprise creases, hinges, deformable and/or flexible material such as silicone, plastics, synthetic or natural rubbers, or features such as apertures, perforations or slots, or any combination thereof, or any other material or feature allowing adjacent stiffer portions to pivot with respect to each other to promote collapsing the collapsible container 102 into the thin form.

The straining device 100 may further comprise at least one handle portion 114, or two handle portions 114 as illustrated in FIG. 1, coupled to or formed in the rim 106. A user can use the handle portions 114 to move, shake, turn over, or otherwise manipulate the collapsible straining device 100. The user can also rest the handle portions 114 on edges of a structure, such as a sink, to suspend the straining device 100 therein.

Although in the illustrated embodiment of FIG. 1, the straining device 100 comprises a circular shape and the wall 110 a circular cross-section, in other embodiments, a straining device and/or its wall(s) may comprise other shapes and/or cross-sections such as rectangular, elliptical, triangular, or any other shape.

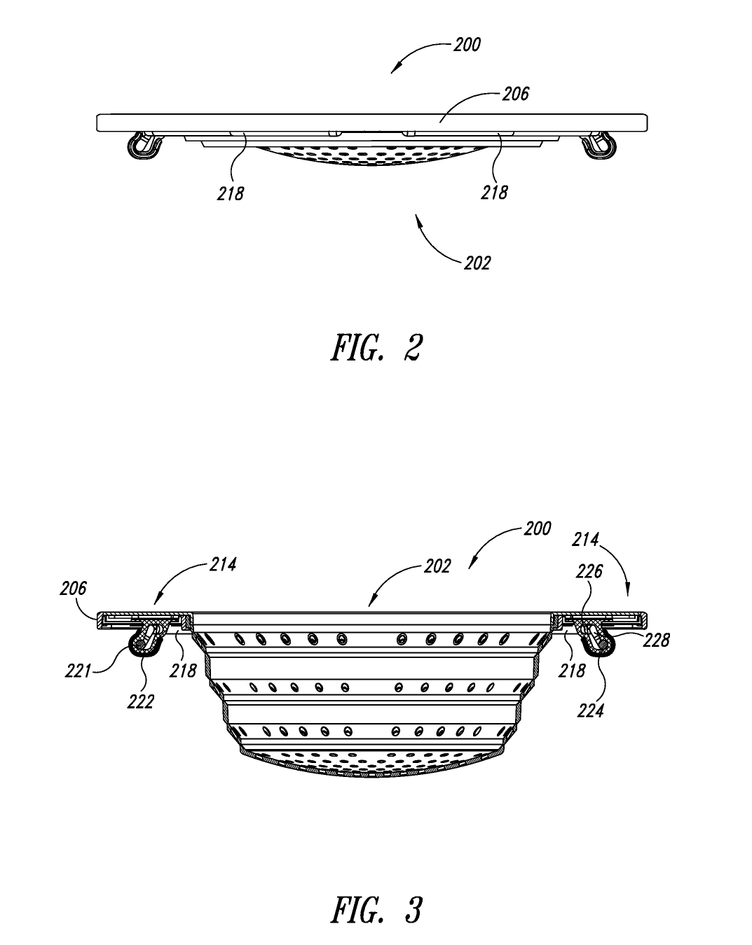

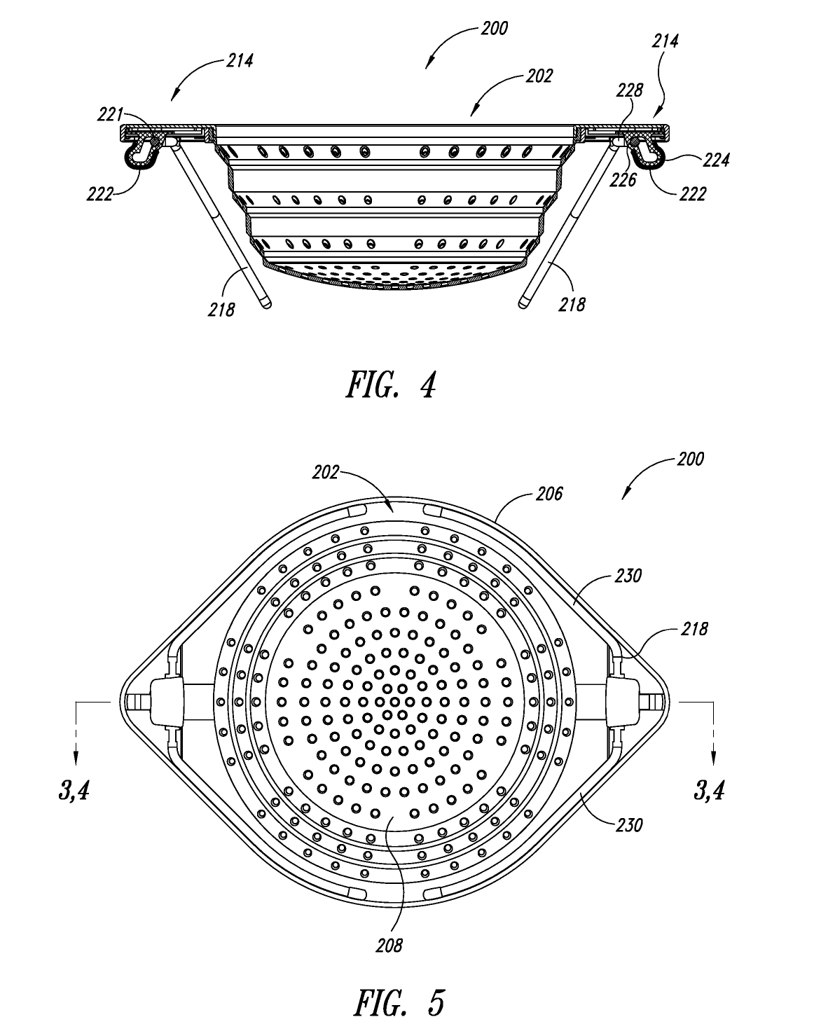

FIG. 2 illustrates a straining device 200 according to another embodiment of the present invention, in which the straining device 200 further comprises at least first and second support members 218 pivotably coupled or mounted to the rim 206. The user can pivot each support member 218 in a first direction, stopping at an open position, illustrated in FIG. 4. In the open position the support members 218 can maintain a position of the straining device 200, for example by supporting the straining device 200 on a surface.

The support members 218 can also pivot in a second direction, different from the first, for example substantially opposite the first, to collapse the support members 218 as illustrated in FIG. 3. When collapsed, the support members 218 are in a closed position. As illustrated in FIG. 2, when both the collapsible container 202 and the support members 218 are collapsed, the straining device 200 assumes a thin form, in which it can be easily stowed away for future use or for transport, for example, in cabinets, luggage or picnic baskets. Therefore, the collapsed straining device 200 can be stored in kitchen cabinets, for example, upright against a wall of the cabinet, or in a narrow space designed for cookie sheets or the like, consuming only a space equivalent to a thickness of the straining device 200 in its collapsed thin form.

As illustrated in FIG. 3, the collapsible straining device 200 may further comprise coupling members 222 operable to affect easy deployment and retraction of the support members 218. The coupling members 222 can slidably engage a portion of the rim 206, for example proximate the handle portions 214. Furthermore, the coupling members 222 may comprise a first recess 224, a second recess 226 and a slot 228 extending therebetween. The first and second recesses 224, 226 can releaseably engage at least a first portion 221 of each support member 218, retaining the support members 218 in the closed and open positions, respectively. The discussion that follows describes an example of an operation of one of the coupling members 222 and its interaction with one of the support members 218 for clarity of description; an operation of the other of the coupling members 222 and its interaction with the other of the support members 218 is substantially identical.

When the support member 218 is in the closed position, the user may exert a first force on the coupling member 222 in a first direction, for example in a direction away from a center of the straining device 200, shifting the first portion 221 of the support member 218 from the first recess 224 to the second recess 226. The first force also slides the coupling member 222 from a first position to a second position. As the first portion 221 travels toward the second recess 226, an interaction of the first portion 221 with surfaces of the first recess 224 and/or the slot 228, forces pivoting of the support member 218 with respect to the coupling member 222. Upon arrival of the first portion 221 in the second recess 226, the support member 218 stops in the open position as illustrated in FIG. 4. Impingement of the first portion 221 against a wall of the second recess 226 maintains the support member 218 in the open position.

After use, the user may exert a second force in a second direction, different from the first, for example substantially opposite the first, on the coupling member 222, sliding the coupling member 222 from the second position to the first position, and shifting the first portion 221 from the second recess 226 to the first recess 224. As the first portion 221 travels toward the first recess 224, an interaction of the first portion 221 with surfaces of the second recess 226 and/or the slot 228, forces pivoting of the support member 218 with respect to the coupling member 222 to return the support member 218 to the closed position illustrated in FIG. 3. Impingement of the first portion 221 against a wall of the first recess 224 maintains the support member 218 in the closed position until future use.

The support members 218 and the coupling members 222 can be fabricated from silicone, plastics, synthetic or natural rubbers, metals such as aluminum, titanium or steel, soft or hard woods, composites such as carbon fiber, or any combination thereof, or any other material capable of maintaining a shape and supporting a weight of the straining device 200 and its contents.

FIG. 5 illustrates a bottom view of the straining device 200 with the support members 218 in the closed position. Each support member 218 may comprise at least two limbs 230. From illustration of the straining device 200 in its collapsed state, as depicted in FIG. 2, it can be appreciated that the user can easily store the collapsible straining device 200 after use. Furthermore, the user can place the collapsed straining device 200 in a dishwasher, allowing space for additional items to be placed therein.

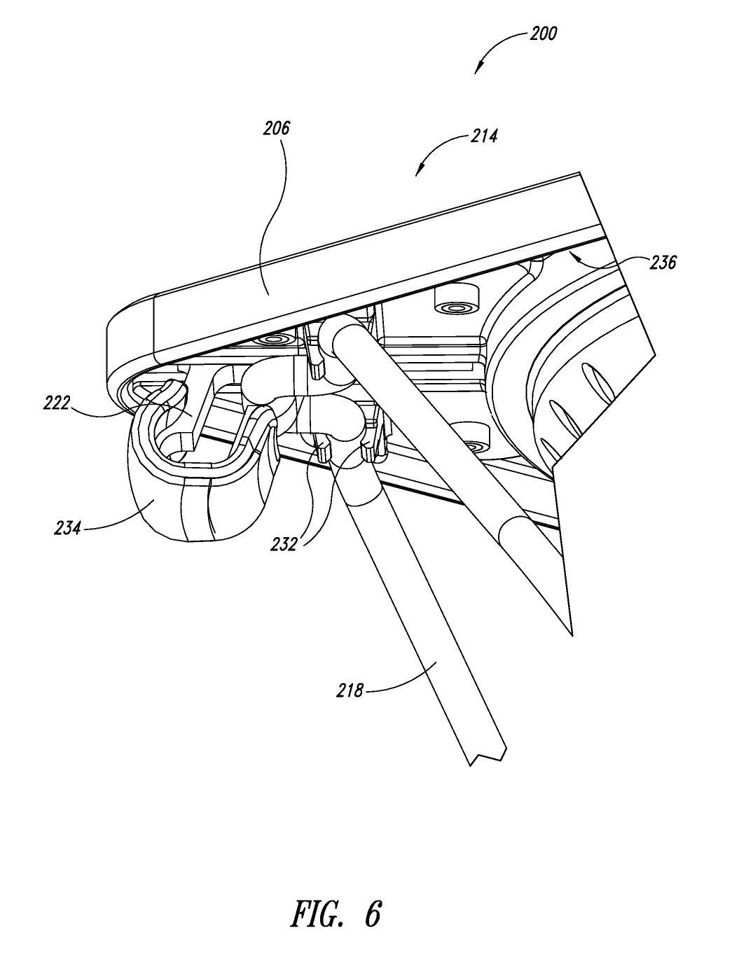

In another aspect, illustrated in FIG. 6, the straining device 200 may comprise at least one optional vice member 232, or two vice members 232 as depicted, rigidly fixed to at least one of a portion of the rim 206 and the handle portion 214. The vice members 232 can pivotably engage another portion of the support members 218, further preventing lateral translation of the support members 218 when the user applies either of the first and second forces to the coupling members 222. In some embodiments, the vice members 232 may respectively be positioned proximate the coupling members 222. Furthermore, the coupling members 222 may each comprise a grip member 234 conforming to a grip of the user for more comfortably manipulating the coupling members 222 to open and close the support members 218 as described above.

The vice members 232 may be fabricated from resilient material such as silicone, metals, plastics, natural or synthetic rubbers, composites, or any combination thereof or any other material capable of temporarily deforming to receive the other portion of the support members 218 and tending to resume its original shape to pivotably retain the other portion of the support members 218 therein. Alternatively, in other embodiments, the vice members 232 may comprise a closed loop shape encircling the other portion of the support members 218. In such embodiments, the vice members 232 may be fabricated from any material capable of pivotably securing the support members 218, such as, but not limited to, silicone, metals, plastics, natural or synthetic rubbers, composites, soft or hard woods, wires, fabrics, foils or films, or any combination thereof.

Furthermore, the rim 206 may comprise a channel 236, illustrated in FIG. 6, operable to receive at least a portion of the supporting members 218 when the supporting members 218 pivot to the closed position, as illustrated in FIG. 2, FIG. 3 and FIG. 5.

As illustrated in FIG. 5, in some embodiments, the base 208 can comprise a width smaller than a width of the rim 206 such that when the collapsible container 202 is in its collapsed form, the base nests, for example concentrically, in the rim 206.

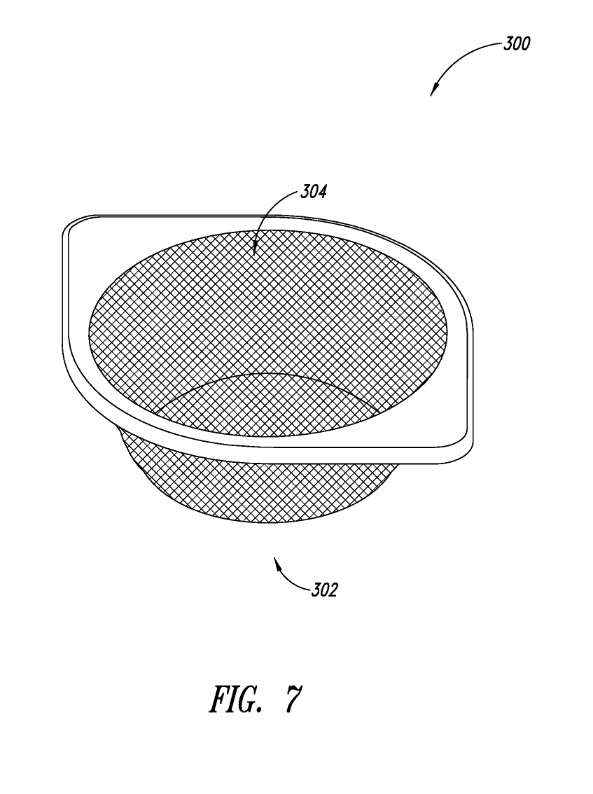

FIG. 7 illustrates a straining device 300 according to yet another embodiment, in which one or more portions of the collapsible container 302 comprises a wire mesh 304. Beyond this difference, the straining device 300 can be similar to an embodiment of the device discussed above.

Other embodiments may not incorporate one or more of the features described, or may comprise additional features. For example, the coupling members 222 may not have the first and second recesses 224, 226 and/or the slot 228. Instead, the coupling member 222 may include any mechanism, hole, slot, and/or hinge that promotes pivoting the support members 218 between the closed and open positions. Furthermore, the apertures 104 may be precluded. Instead, the collapsible container 102, 202 may comprise elongated slots, extending substantially radially, for straining. Such slots can also serve as the transitions in the collapsible container 102, 202 that promote collapsing the collapsible container 102, 202. Moreover, the collapsible straining device 200 may comprise of only one support member 218 in some embodiments, in which the device can be supported against other structure, be balanced on one support member 218 or comprise at least one auxiliary support that in combination with the one support member 218 maintains a position of the collapsible straining device. An individual of ordinary skill in the art, having reviewed this disclosure, will appreciate these and other variations that can be made to the straining device 100, 200, 300 without deviating from the spirit of the invention.

In addition, although the use of the straining device 100, 200, 300 has been described with respect to uses in the kitchen, it can be appreciated that the straining device 100, 200, 300 can be used for any application in which it is desired to separate items having a size greater than the apertures 104 or openings in the wire mesh 304 from items having a size smaller than the apertures 104 or openings in the wire mesh 304. Such uses may be had in fields such as, but not limited to, gardening, precious metals extraction, drying fabrics, or construction applications.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and equivalents thereof.

1. A device for straining liquids and particles from solid food items, the device comprising:
a collapsible container operable to collapse into a thin form, the collapsible container having a plurality of apertures therein,
a rim coupled to an outer edge of the collapsible container, and
a base coupled to the collapsible container to remain a fixed distance from the rim during use and to set proximate thereto after use when the collapsible container is collapsed into the thin form.

2. The device of claim 1 wherein the collapsible container is fabricated from a flexible unitary body of material.

3. The device of claim 1, further comprising at least one wall interposed between the rim and the base, the at least one wall being adapted to form at least one transition therein operable to expand the collapsible container, to form a concavity to retain the food items during use, and to collapse the collapsible container into the thin form after use.

4. The device of claim 1 wherein a width of the base is smaller than a width of the rim and the base concentrically nests in the rim after use when the collapsible container is collapsed into the thin form.

5. The device of claim 1, further comprising at least first and second support members pivotably coupled to the rim, operable to pivot with respect to the rim in a first direction to an open position and rest on a surface to maintain a position of the device during use, and to pivot in a second direction with respect to the rim, different from the first, to a closed position to rest proximate the rim after use.

6. The device of claim 5 wherein the rim comprises a channel formed therein and the first and second support members at least partially nest in the channel when in the closed position.

7. The device of claim 5 wherein the first support member is positioned substantially diametrically opposing the second support member.

8. The device of claim 5, further comprising:
a first coupling member pivotably coupling the first support member to the rim and having a first recess and a second recess, the first recess operable to releaseably engage the first support member and retain the first support member in the closed position, the second recess operable to releaseably engage the first support member and retain the first support member in the open position; and
a second coupling member pivotably coupling the second support member to the rim and having a first recess and a second recess, the first recess operable to releaseably engage the second support member and retain the second support member in the closed position, the second recess operable to releaseably engage the second support member and retain the second support member in the open position.

9. The device of claim 8 wherein:
the first and second coupling members slidably engage the rim, respectively;
a first force applied to the first and second coupling members respectively translates the coupling members from a first to a second position, shifting the first and second support members from the first recess to the second recess of the first and second coupling members, respectively, an interaction of a surface of the recesses with the first and second support members pivoting the first and second support members from the closed position to the open position; and
a second force applied to the first and second coupling members respectively translates the coupling members from the second to the first position, shifting the first and second support members from the second recess to the first recess of the first and second coupling members, respectively, an interaction of the surface of the recesses with the first and second support members pivoting the first and second support members from the open position to the closed position.

10. The device of claim 9, further comprising at least one vice member rigidly fixed to the rim, pivotably engaging the first and second support members to substantially prevent lateral translation of the first and second support members when at least one of the first and second forces is applied to at least one of the coupling members.

11. The device of claim 2 wherein the rim comprises at least one handle portion formed therein.

12. A collapsible straining device comprising:
means for expanding the collapsible straining device, forming a concavity therein during use, and allowing collapsing of the straining device into a thin form after use;
a rim coupled to a first edge of the expanding means;
a base coupled to a second edge of the expanding means to remain a fixed distance from the rim during use, to form the concavity during use, and to be set proximate thereto after use;
straining means for allowing passage of particles having a size smaller than a predetermined size through the concavity and blocking from passage therethrough particles having a size larger than the predetermined size; and
supporting means for supporting the collapsible straining device on at least one of a structure and a surface.

13. The collapsible straining device of claim 12 wherein the means for expanding and collapsing the device comprises at least one of a flexible material, a hinge, a crease, a perforation and an opening.

14. The collapsible straining device of claim 12 wherein the straining means comprises at least one of a plurality of apertures, at least one slot, and a wire mesh.

15. The collapsible straining device of claim 12 wherein the supporting means comprises:
at least one support member having at least one limb operable to maintain a position of the collapsible straining device; and
mounting means for pivotably mounting the support member to the rim.

16. The collapsible straining device of claim 15 wherein the mounting means comprises:
a coupling member slidably engaging the rim and having a first recess operable to receive a portion of the support member and retain the support member in a closed position proximate the rim when the coupling member is slid to a first position, and a second recess operable to receive the portion of the support member and retain the support member in an open position to rest against at least one of the surface and the structure, when the coupling member is slid to a second position.
